(19) United States
(12) Patent Application Publication
(10) Pub. No.: US 2010/0110393 A1
(43) Pub. Date: May 6, 2010

(54) PROJECTOR

(75) Inventors: Chien-Fu Chen, Tu-Cheng (TW); Wei-Ping Hsu, Tu-Cheng (TW); Chia-Hung Kao, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/391,528

(22) Filed: Feb. 24, 2009

(30) Foreign Application Priority Data
Oct. 30, 2008 (CN) 200810305296.2

(51) Int. Cl. G03B 21/16

(52) U.S. Cl. 353/58

(57) ABSTRACT

A projector includes a first exhaust fan, a second exhaust fan, a casing, an optical engine, a circuitry system, and a projection lens module. The casing includes a front wall, a rear wall opposite to the front wall, a first sidewall, and a second sidewall opposite to the first sidewall. The first sidewall defines a first air inlet adjacent to the front wall and a second air inlet adjacent to the rear wall. The second sidewall defines a first and second air outlet aligned with the first and second air inlet respectively. The first and second exhaust fans are arranged corresponding to the first and second air outlet respectively. The projection lens module and the circuitry system are positioned in the casing between the first air inlet and the first air outlet. The optical engine is positioned in the casing between the second air inlet and the second air outlet.

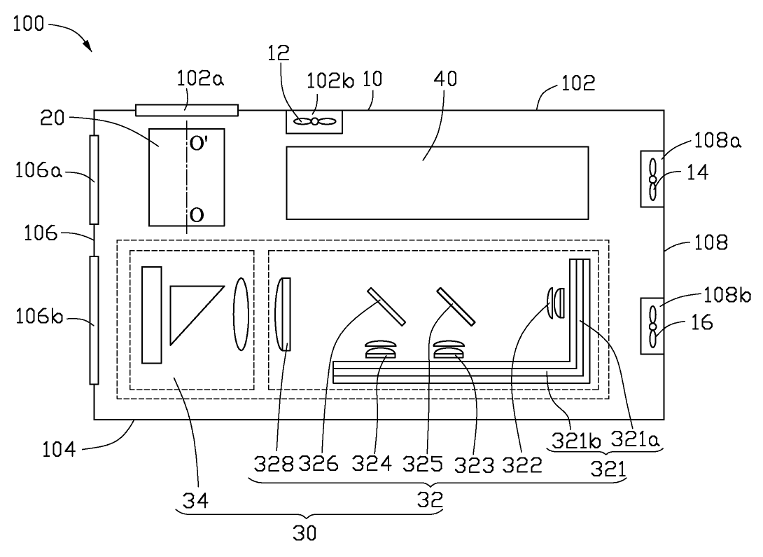

### BACKGROUND

1. Technical Field

The disclosure relates to projecting technology and, particularly, to a projector with effective heat dissipation.

2. Description of the Related Art

Development trends of projectors are towards improving image quality, brightness and compactness. However, the more compact a projector is, the more quickly it can get overheated. If a project is overheated, the performance and reliability of the projectors will suffer, together with deteriorated image quality and shortened service life span. Hence, heat dissipation in projectors is of great importance in projector design.

### BRIEF DESCRIPTION OF THE DRAWINGS

The FIGURE is a schematic view of a projector, according to an exemplary embodiment.

### DETAILED DESCRIPTION

Referring to the FIGURE, a projector 100 according to an exemplary embodiment includes a casing 10, inside of which are a projection lens module 20 with an optical axis OO′, an optical engine 30, and a circuitry system 40. The casing 10 includes a front wall 102, a rear wall 104 opposite to the front wall 102, a first sidewall 106, and a second sidewall 108 opposite to the first sidewall 106. The front wall 102, the second sidewall 108, the rear wall 104, and the first sidewall 106 are connected in sequence. An aperture 102a is defined in the front wall 102 adjacent to the first sidewall 106, corresponding to the projection lens module 20. A front air inlet 102b is defined in the front wall 102 with a location different from that of the aperture 102a. The first sidewall 106 defines a first air inlet 106a adjacent to the front wall 102, and a second air inlet 106b adjacent to the rear wall 104. The second sidewall 108 defines a first air outlet 108a and a second air outlet 108b substantially aligned with the first air inlet 106a and the second air inlet 106b, respectively.

The projector 100 further includes a suction fan 12, a first exhaust fan 14, and a second exhaust fan 16. The suction fan 12 is arranged corresponding to the front air inlet 102b for pulling air into the casing 10. The first and second exhaust fans 14, 16 are arranged corresponding to the first and second air outlets 108a, 108b, respectively.

The projection lens module 20 is substantially aligned with the aperture 102a of the front wall 102 and the optical axis OO′ of the projection lens module 20 is approximately perpendicular to the front wall 102. The projection lens module 20 is positioned between the first air inlet 106a and the first air outlet 108a.

The optical engine 30 includes a light-source module 32 and a light modulation module 34.

The light-source module 32 is configured for generating light, and includes an L-shaped heat sink 321, a red light source 322, a green light source 323, a blue light source 324, a first dichroic mirror 325, a second dichroic mirror 326, and a condensing lens 328. The heat sink 321 includes a first heat sink portion 321a approximately perpendicular to the front wall 102 and a second heat sink portion 321b approximately parallel to the front wall 102. The red light source 322 is mounted on the first heat sink portion 321a. The green light source 323 and the blue light source 324 are mounted on the second heat sink portion 321b. The first dichroic mirror 325 and the second dichroic mirror 326 are positioned between the red light source 322 and the condensing lens 328. Light emitted from the green light source 323 is reflected by the first dichroic mirror 325 towards the second dichroic mirror 326 and is propagated through the second dichroic mirror 326 towards the condensing lens 328. Light emitted from the blue light source 324 is reflected by the second dichroic mirror 326 towards the condensing lens 328. Light emitted from the red light source 322 is propagated through the first dichroic mirror 325 and the second dichroic mirror 326 towards the condensing lens 328. The condensing lens 328 is configured for condensing the light from the red, green, and blue light source 322, 323, 324. In this embodiment, the red light source 322, the green light source 324 and the blue light source 326 are light emitting diodes (LED).

The light modulation module 34 is configured for modulating the light generated by the light-source module 32 to produce images towards the projection lens module 20 which focuses the images and projects the images onto a screen (not shown). The light modulation module 34 and the light-source module 32 are arranged between the second air inlet 106b and the second air outlet 108b, and are arranged in order from the second air inlet 106b to the second air outlet 108b. The projection lens module 20 is positioned adjacent to the light modulation module 34 of the optical engine 30.

The circuitry system 40 is electrically connected to the optical engine 30, and is configured for controlling the light-source module 32, the light modulation module 34, the suction fan 12, the first exhaust fan 14, and the second exhaust fan 16. The circuitry system 40 is positioned between the projection lens module 20 and the second sidewall 108, and substantially faces the front air inlet 102b.

In the casing 10 of the projector 100, when the suction fan 12, the first exhaust fan 14, and the second exhaust fan 16 are activated by the circuitry system 40, air from the first air inlet 106a flows through the projection lens module 20 and the circuitry system 40 to take away heat generated by the projection lens module 20 and the circuitry system 40, and is exhausted by the first exhaust fan 14 from the first air outlet 108a so that the projection lens module 20 and the circuitry system 40 are cooled. Air from the suction fan 12 flows through the circuitry system 40 to take away heat generated by the circuitry system 40 and is exhausted by the first exhaust fan 14 so that the circuitry system 40 is further cooled. Air from the second air inlet 106b flows through the light modulation module 34 and the light-source module 32 to take away heat generated by the light-source module 32 and the light modulation module 34 and is exhausted by the second exhaust fan 16 from the second air outlet 108b so that the light modulation module 34 and the light-source module 32 are cooled. In this way, heat generated in the casing 10 can be efficiently dissipated.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A projector comprising:
a casing comprising a front wall, a rear wall opposite to the front wall, a first sidewall, and a second sidewall opposite to the first sidewall, the first sidewall defining a first air inlet adjacent to the front wall and a second air inlet adjacent to the rear wall, the second sidewall defining a first air outlet and a second air outlet substantially aligned with the first air inlet and the second air inlet respectively;
a first exhaust fan;
a second exhaust fan;
an optical engine configured for generating images;
a circuitry system configured for controlling the optical engine, the first exhaust fan and the second exhaust fan; and
a projection lens module configured for projecting the images generated by the optical engine onto a screen; wherein
the first and second exhaust fan arranged corresponding to the first and second air outlets, respectively, the projection lens module and the circuitry system positioned in the casing between the first air inlet and the first air outlet, the optical engine positioned in the casing between the second air inlet and the second air outlet.

2. The projector as claimed in claim 1, wherein the projector further comprises a suction fan, an aperture is defined in the front wall adjacent to the first sidewall, an front air inlet is defined in the front wall between the aperture and the second sidewall, the front air let faces the circuitry system, the suction fan is arranged corresponding to the front air inlet and controlled by the circuitry system.

3. The projector as claimed in claim 2, wherein the projector lens module is aligned with the aperture.

4. The projector as claimed in claim 3, wherein the optical engine comprises a light-source module and a light modulation module, the light modulation module and the light-source module are arranged in order from the second air inlet to the second air outlet, the light-source module is configured for generating light, the light modulation module is configured for modulating the light generated by the light-source module.

5. The projector as claimed in claim 4, wherein the light-source module comprises a red light source, a green light source, a blue light source, a first dichroic mirror, a second dichroic mirror, and a condensing lens, the first dichroic mirror and the second dichroic mirror are positioned between the red light source and the condensing lens, light emitted from the green light source is reflected by the first dichroic mirror towards the second dichroic mirror and is propagated through the second dichroic mirror towards the condensing lens, light emitted from the blue light source is reflected by the second dichroic mirror towards the condensing lens, light emitted from the red light source is propagated through the first dichroic mirror and the second dichroic mirror towards the condensing lens.

6. The projector as claimed in claim 5, wherein the optical engine further comprises a L-shaped heat sink, the red, the green and the blue light sources are mounted on the heat sink.

7. The projector as claimed in claim 6, wherein the heat sink includes a first heat sink portion approximately perpendicular to the front wall and a second heat sink portion approximately parallel to the first sidewall, the red light source is mounted on the first heat sink portion, the green and the blue light sources are mounted on the second heat sink portion.
